(19) United States
(12) Patent Application Publication
(10) Pub. No.: US 2023/0312798 A1
(43) Pub. Date: Oct. 5, 2023

(54) FUNCTIONALIZED HYDROGENATED POLYMERS

(71) Applicant: The Goodyear Tire & Rubber Company, Akron, OH (US)

(72) Inventors: Thomas Franklin Spilker, Broadview Heights, OH (US); Margaret Flook Vielhaber, Kent, OH (US); Aaron Patrick Murray, Chardon, OH (US)

(21) Appl. No.: 18/155,799

(22) Filed: Jan. 18, 2023

Related U.S. Application Data
(60) Provisional application No. 63/362,214, filed on Mar. 31, 2022.

(51) Int. Cl. C08F 279/02; C08K 3/04; C08K 3/36

(52) U.S. Cl. CPC C08F 279/02; C08K 3/04; C08K 3/36

(57) ABSTRACT

A hydrogenated functionalized polymer comprises a functionalized polydiene, which selectively hydrogenated to a predetermined level of saturation along at least a polydiene portion of the functionalized polydiene. The functionalized polydiene is a reaction product of a living anionic elastomer initiated with a functionalized lithium initiator of the formula (I)

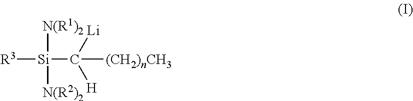

wherein n is 1 to 8; and R¹, R², and R³ are independently selected from alkyl groups containing from 1 to 8 carbon atoms. The polymer is also a reaction product of (1) the living anionic elastomer and a functional terminator, both of which produce a polymer having chains of the structural formula (II)

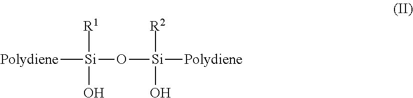

Each Polydiene represents polymer chains comprising at least one partially or fully hydrogenated diene monomer. R¹ and R² independently represent alkyl groups containing 1 to 8 carbon atoms.

### FIELD OF THE INVENTION

The disclosure relates to functionalized rubbery polymers that are selectively saturated by hydrogenation. It is intended for use in rubber applications, such as for tires, and will be described with particular reference thereto. However, it is appreciated that the present exemplary embodiments are also amenable to other like applications.

### BACKGROUND OF THE INVENTION

Most rubber polymers are derived from a conjugated diene and contain unsaturation points along the hydrocarbon polymer chain for crosslinking. Over time, a cured rubber can suffer degradation caused by light, oxygen (ozone), and heat exposure. The ozone attacks double bonds in the rubber chains, thus accelerating aging. As aging occurs, physical properties change in the cured rubber product.

Additives, such as antiozonants, are widely used to protect rubber against ozone deterioration. To work effectively, they must possess characteristics that allow them to migrate to the rubber surface where they act as a barrier. Alternative approaches are desired in which an additive is not required. Thus, a saturated polymer is proposed to improve aging in cured rubber products.

However, a rubber compound must continue to perform to its desired specifications. Longevity cannot be improved to the detriment of performance. Using tires as an illustrative article, tread formulations that contain silica filler exhibit a number of important performance advantages over those that use carbon black. In tread formulations, the silica is believed to (a) lower rolling resistance, (b) provide better traction on snow, and (c) lower noise generation, when compared with conventional tires filled with carbon black. Therefore, a polymer is desired that provides better aging while maintaining strong compatibility with silica filler.

### SUMMARY OF THE DISCLOSURE

The present disclosure provides a low-cost means for generating a polymer that can be incorporated in the manufacture of rubber products, such as tires, when better aging and performance is desired.

One embodiment of the disclosure is directed to a hydrogenated functionalized polymer bearing a functionality that displays low hysteresis and good compatibility with fillers, such as carbon black and silica. The disclosed polymer is contemplated for use in a wide variety of rubber articles that require special properties either minimally or not affected by ozone degradation.

One embodiment of the disclosure is directed to a hydrogenated functionalized polymer, which comprises a functionalized polydiene that is selectively hydrogenated to a predetermined level of saturation along at least a polydiene portion of the functionalized polydiene. The functionalized polydiene is a reaction product of a living anionic elastomer initiated with a functionalized lithium initiator of the formula (I)

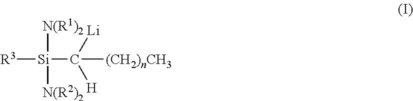

wherein n is 1 to 8; and R¹, R², and R³ are independently selected from alkyl groups containing from 1 to 8 carbon atoms. The polymer is also a reaction product of (1) the living anionic elastomer and (2) a functional terminator, both of which produce a polymer having chains of the structural formula (II)

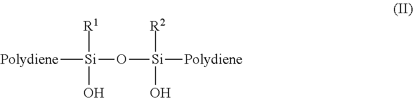

Each Polydiene represents polymer chains comprising at least one partially or fully hydrogenated diene monomer. R¹ and R² independently represent alkyl groups containing 1 to 8 carbon atoms.

One embodiment of the disclosure is directed to a hydrogenated functionalized polymer, which comprises an end-functionalized polydiene that is selectively hydrogenated to achieve a predetermined level of saturation along at least the polydiene portion of the functionalized polydiene. In one embodiment, the functionalized polydiene is a reaction product of (1) a living rubbery polymer; and (2) a polymerization terminator of formula III

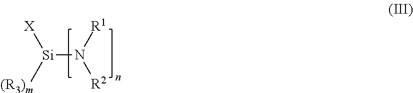

where X is Cl, Br, or I.

In such embodiment, m is an integer from 0 to 2, n is an integer from 1 to 3, with the proviso that n+m=3; R¹, R² are independently C1 to C18 alkyl, aryl, or a combination thereof, or R¹, R² are independently —SiR³ where R is independently alkyl, aryl, alkoxy, or disubstituted amino, or R¹ and R² taken together with their common nitrogen atom and optionally a sulfur or oxygen heteroatom to form a five to eight membered ring; R³ is hydrogen, or C1 to C18 alkyl, aryl, or a combination thereof, or R³ is —SiR³ where R is independently alkyl, aryl, alkoxy, or disubstituted amino, or R³ is —R⁶—R⁷, where R⁶ is C1 to C3 alkanediyl and R⁷ is selected from the following structures —S—Z, —N(R⁸)(R⁹), —O(Y), or Si(OR¹⁰)₃, where R⁸ and R⁹ are independently C1 to C18 alkyl, aryl, or a combination thereof; Y and Z are independently selected from the group consisting of methoxymethyl, tetrahydropyranyl, tetrahydrothiopyranyl, tetrahydrofuranyl, tert-butyl, allyl, 1-ethoxyethyl, benzyl, triphenylmethyl, triethylsilyl, triisopropylsilyl, trimethylsilyl, tert-butyl dimethyl silyl, tert-butyl diphenyl silyl, and isopropyldimethylsilyl, and R¹⁰ are independently C1 to C4 alkyl; or when m=1.

In one embodiment, the functionalized polydiene is a reaction product of (1) a living rubbery polymer; and (2) a polymerization terminator of formula IV

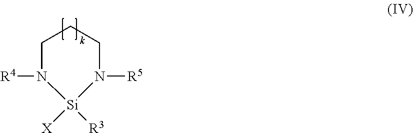

In such embodiment, R⁴, R⁵ are independently C1 to C18 alkyl, aryl, or a combination thereof, or R⁴, R⁵ are independently —SiR³ where R is independently alkyl, aryl, alkoxy, or disubstituted amino, X and R³ are as defined previously, and k is an integer from 0 to 10; wherein the living rubbery polymer is comprised of polymer chains having functional groups of the structure in the backbone thereof

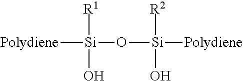

and wherein R¹¹ and R¹² can be the same or different and represent alkyl groups containing from 1 to 8 carbon atoms.

Some representative examples of the polymerization terminators that can be used include those having any of the following structures (V)-(VIII):

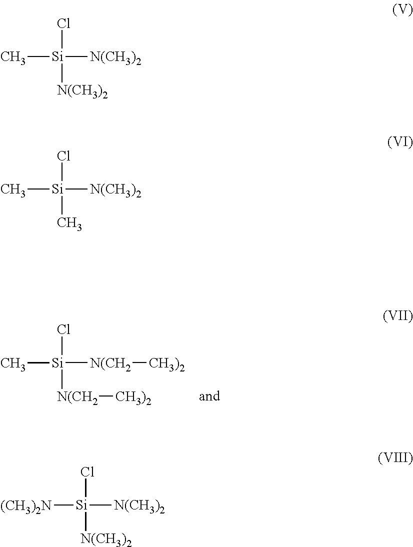

The subject invention also reveals a functionalized rubber which—prior to its saturation by hydrogenation—is derived from polymer chains of the structural formula II:

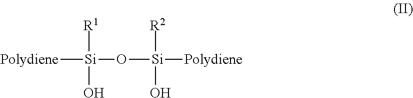

wherein polydiene represents a polymer chain which is comprised of at least one diene monomer and wherein R¹ and R² can be the same or different and represent alkyl groups containing form 1 to 8 carbon atoms. Such polydienes are at least partially saturated in the final rubber.

The present invention further reveals a method of synthesizing a functionalized rubber which comprises the steps of (1) initiating the polymerization of a conjugated diene monomer in an inert organic liquid medium with a functionalized lithium initiator; (2) allowing the polymerization to continue in the inert organic liquid medium until a desired level on monomer conversion has been attained to produce a rubbery polymer having living polymer chains; (3) adding a polymerization terminator to the living polymer chains to produce the functionalized rubber; (4) hydrogenating the functionalized rubber to saturate it to a select level; (5) distributing throughout the inert organic liquid medium an acid and water under conditions of agitation; and (6) recovering the functionalized rubber from the inert liquid organic medium.

In such method, the functionalized lithium initiator has the structural formula (I):

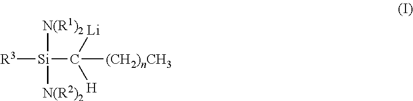

wherein n is an integer from 1 to 8, wherein R¹, R², and R³ can be the same or different and are selected from alkyl groups containing from 1 to 8 carbon atoms. The functionalized rubber has polymer chains of the structural formula II:

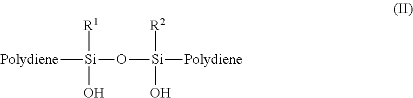

wherein Polydiene represents polymer chains which are comprised of at least one diene monomer and wherein R¹ and R² can be the same or different and represent alkyl groups containing from 1 to 8 carbon atoms.

The initiation pathway, termination step, and hydrogenation step of this process can more specifically be depicted by the following illustrative, but non-limiting, example:

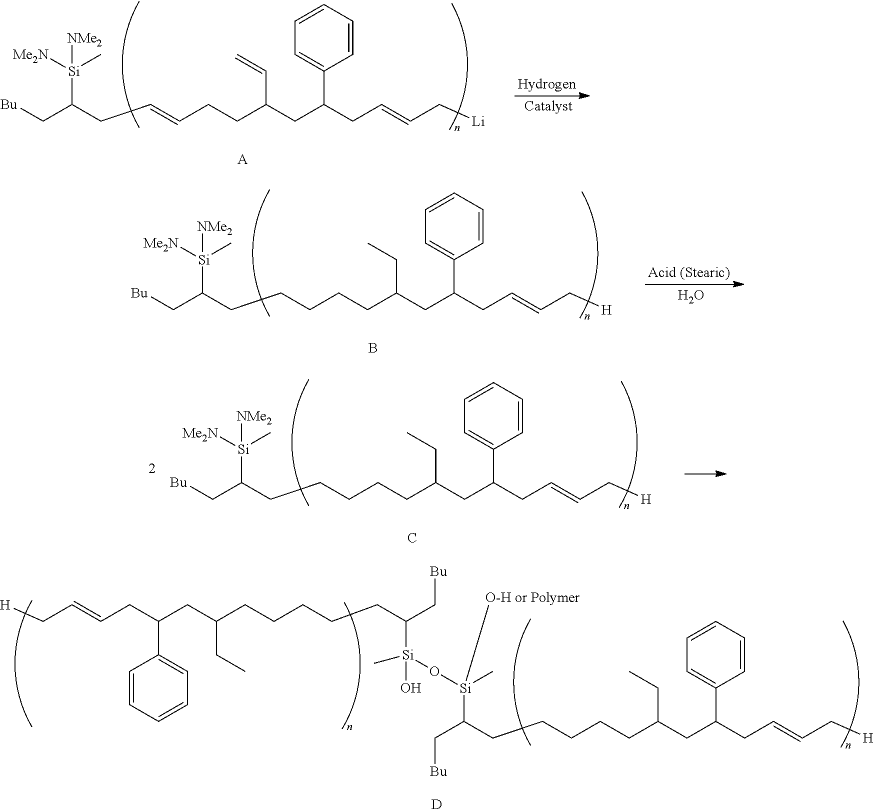

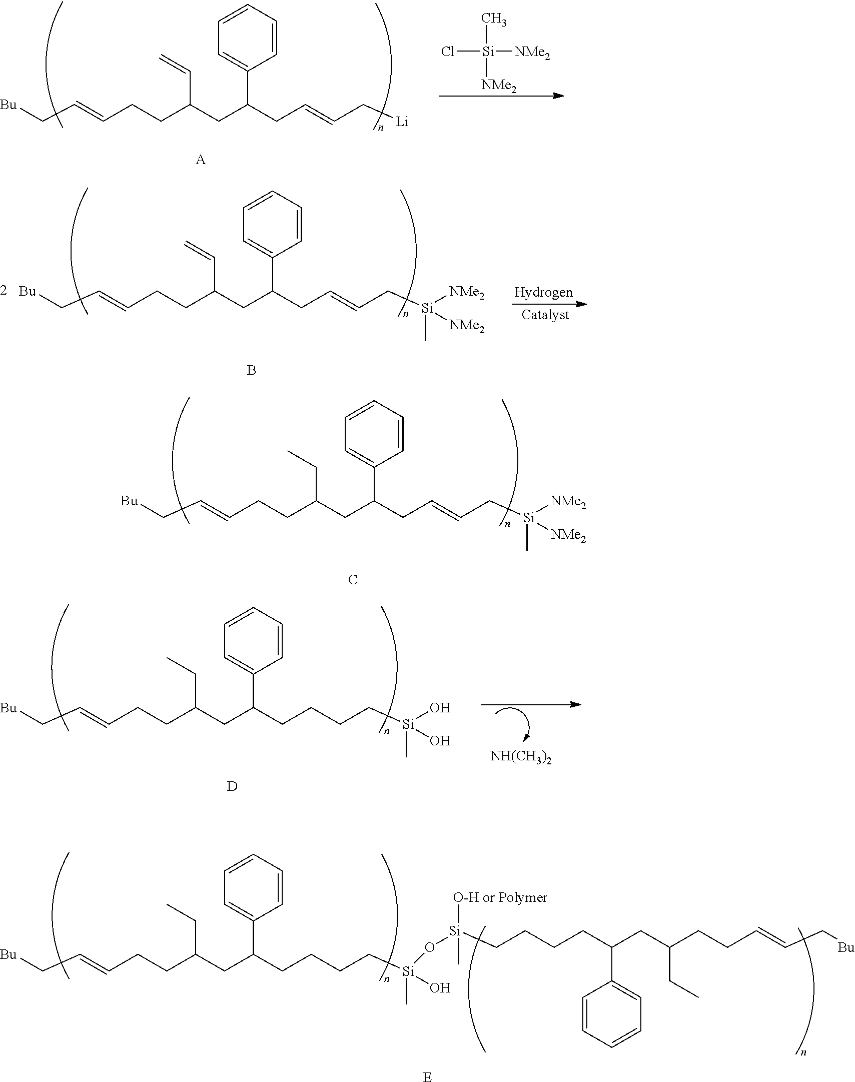

These rubbery polymers can include, hydrogenated functionalized high cis-1,4-polybutadiene rubber, hydrogenated functionalized polyisoprene rubber, hydrogenated functionalized styrene-butadiene rubber, hydrogenated functionalized styrene-isoprene rubber, hydrogenated functionalized styrene-isoprene-butadiene rubber, and the like. In any case, improved polymer properties are realized because the functionalized groups therein improve the compatibility of the rubber with the types of fillers that are typically used in rubber compounds, such as carbon black and silica, and the saturated polydiene portion therein improves aging.

### DETAILED DESCRIPTION OF THE INVENTION

The present disclosure is directed to a hydrogenated functionalized polymer that is produced by selectively hydrogenating a functionalized rubber to generate a predetermined saturation level of the rubber. The hydrogenation of the functionalized rubber can be performed using methods and catalysts known in the art. Particularly, the final polymer is produced by hydrogenating a functionalized polydiene instead of functionalizing a saturated polymer.

By “selective” hydrogenation, termination of the hydrogenation reaction is performed after either full or partial conversion of all double bonds in the functionalized polymer and, more particularly, the butadiene and isoprene units in the functionalized polymer. In one embodiment, the hydrogenation is terminated when these units are from about 10 percent to about 40 percent, or alternatively from 40 percent to about 80 percent, or alternatively from about 80 percent to about 100 percent, saturated by hydrogenation of the functionalized polymer. In one embodiment, the final polymer is fully saturated along at least the polydiene portion of the chain. In one embodiment, the hydrogenation is terminated when the polydiene portion and/or the functionalized portion are from about 10 percent to about 40 percent, or alternatively from 40 percent to about 80 percent, or alternatively from about 80 percent to about 100 percent, saturated by hydrogenation of the functionalized polymer.

In the contemplated embodiment, the functionalized rubber disclosed in commonly owned U.S. Ser. No. 17,454,120, filed Dec. 9, 2020, the contents of which are fully incorporated herein, is at least partially saturated by hydrogenation. That patent discloses an initiation pathway and termination step that can be used to make a wide variety of functionalized rubbers. These rubbers will normally be homopolymers or copolymers of conjugated diolefin monomers and can further contain vinyl aromatic monomers.

The polymerizations used in synthesizing the functionalized rubbers of this invention are normally carried out as solution polymerizations in an inert organic medium utilizing a lithium catalyst. The vinyl content of the functionalized rubbery polymer made is controlled by the amount of modifier present during the polymerization.

The rubbery polymers synthesized using the modifiers of this invention can be made by the homopolymerization of a conjugated diolefin monomer or by the copolymerization of a conjugated diolefin monomer with a vinyl aromatic monomer. It is, of course, also possible to make rubbery polymers by polymerizing a mixture of conjugated diolefin monomers with one or more ethylenically unsaturated monomers, such as vinyl aromatic monomers. The conjugated diolefin monomers which can be utilized in the synthesis of rubbery polymers in accordance with this invention generally contain from 4 to 12 carbon atoms. Those containing from 4 to 8 carbon atoms are generally preferred for commercial purposes. For similar reasons, 1,3-butadiene and isoprene are the most commonly utilized conjugated diolefin monomers. Some additional conjugated diolefin monomers that can be utilized include 2,3-dimethyl-1,3-butadiene, piperylene, 3-butyl-1,3-octadiene, 2-phenyl-1,3-butadiene, and the like, alone or in admixture.

Some representative examples of ethylenically unsaturated monomers that can potentially be copolymerized into rubbery polymers using the modifiers of this invention include alkyl acrylates, such as methyl acrylate, ethyl acrylate, butyl acrylate, methyl methacrylate and the like; vinylidene monomers having one or more terminal CH2═CH— groups; vinyl aromatics such as styrene, a-methylstyrene, bromostyrene, chlorostyrene, fluorostyrene and the like; α-olefins such as ethylene, propylene, 1-butene and the like; vinyl halides, such as vinylbromide, chloroethane (vinylchloride), vinylfluoride, vinyliodide, 1,2-dibromoethene, 1,1-dichloroethene (vinylidene chloride), 1,2-dichloroethene and the like; vinyl esters, such as vinyl acetate; α, β-olefinically unsaturated nitriles, such as acrylonitrile and methacrylonitrile; α, β-olefinically unsaturated amides, such as acrylamide, N-methyl acrylamide, N,N-dimethylacrylamide, methacrylamide and the like.

Rubbery polymers which are copolymers of one or more diene monomers with one or more other ethylenically unsaturated monomers will normally contain from about 50 weight percent to about 99 weight percent conjugated diolefin monomers and from about 1 weight percent to about 50 weight percent of the other ethylenically unsaturated monomers in addition to the conjugated diolefin monomers. For example, copolymers of conjugated diolefin monomers with vinylaromatic monomers, such as styrene-butadiene rubbers which contain from 50 to 95 weight percent conjugated diolefin monomers and from 5 to 50 weight percent vinylaromatic monomers, are useful in many applications.

Vinyl aromatic monomers are probably the most important group of ethylenically unsaturated monomers which are commonly incorporated into polydienes. Such vinyl aromatic monomers are, of course, selected so as to be copolymerizable with the conjugated diolefin monomers being utilized. Generally, any vinyl aromatic monomer which is known to polymerize with organolithium initiators can be used. Such vinyl aromatic monomers typically contain from 8 to 20 carbon atoms. Usually, the vinyl aromatic monomer will contain from 8 to 14 carbon atoms. The most widely used vinyl aromatic monomer is styrene. Some examples of vinyl aromatic monomers that can be utilized include styrene, 1-vinylnaphthalene, 2-vinylnaphthalene, α-methylstyrene, 4-phenylstyrene, 3-methylstyrene and the like.

Some representative examples of rubbery polymers which can be functionalized in accordance with this invention include polybutadiene, polyisoprene, styrene-butadiene rubber (SBR), α-methylstyrene-butadiene rubber, α-methylstyrene-isoprene rubber, styrene-isoprene-butadiene rubber (SIBR), styrene-isoprene rubber (SIR), isoprene-butadiene rubber (IBR), α-methylstyrene-isoprene-butadiene rubber and α-methylstyrene-styrene-isoprene-butadiene rubber.

Functionalized high vinyl polybutadiene rubber and styrene-butadiene rubbers made in accordance with this invention typically contain from 0 to 40 weight percent styrene and from 60 weight percent to 100 weight percent 1,3-butadiene. The functionalized styrene-butadiene rubber of this invention will more typically contain from 15 to 40 weight percent bound styrene and from 60 to 85 weight percent bound 1,3-butadiene. For instance, the functionalized styrene-butadiene rubber of this invention can contain from 18 to 24 weight percent styrene and from 76 to 82 weight percent 1,3-butadiene or from 24 to 32 weight percent styrene and from 68 to 76 weight percent 1,3-butadiene or 32 to 40 weight percent styrene and from 60 to 68 weight percent 1,3-butadiene.

In solution polymerizations the inert organic medium which is utilized as the solvent will typically be a hydrocarbon which is liquid at ambient temperatures which can be one or more aromatic, paraffinic or cycloparaffinic compounds. These solvents will normally contain from 4 to 10 carbon atoms per molecule and will be liquids under the conditions of the polymerization. It is, of course, important for the solvent selected to be inert. The term “inert” as used herein means that the solvent does not interfere with functionalized initiator, the polymerization reaction, or react with the polymers made thereby. Some representative examples of suitable organic solvents include pentane, isooctane, cyclohexane, normal hexane, benzene, toluene, xylene, ethylbenzene and the like, alone or in admixture. Saturated aliphatic solvents, such as cyclohexane and normal hexane, are most preferred.

(1) Initiating the Polymerization of a Conjugated Diene Monomer in an Inert Organic Liquid Medium with a Functionalized Lithium Initiator:

The functionalized lithium initiators which are used in synthesizing the functionalized rubbers of this invention are of the structural formula I:

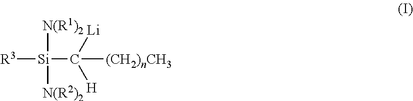

wherein n is an integer from 1 to 8, wherein R groups can be the same or different and represents hydrogen atoms or alkyl groups containing from 1 to 4 carbon atoms, R¹, R², and R³ can be the same or different and are selected from alkyl groups containing from 1 to 8 carbon atoms. It is normally preferred for n to represent an integer from 3 to 5 with it being most preferred for n to represent 4. It normally preferred for R¹, R², and R³ to represent alkyl groups containing from 1 to 4 carbon atoms with it being more preferred for R¹, R², and R³ to represent alkyl groups containing from 1 or 2 carbon atoms (for R¹, R², and R³ to be methyl or ethyl groups).These functional initiators are made by reacting an alkyl lithium compound with a bis-(dialkylamino)vinylalkylsilane in an inert organic solvent in the presence of a polar modifier, such as tetramethylethylenediamine (TMEDA). This reaction can be depicted as follows:

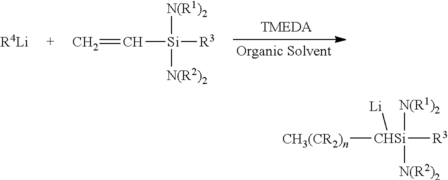

wherein n is an integer from 1 to 8, wherein R groups can be the same or different and represents hydrogen atoms or alkyl groups containing from 1 to 4 carbon atoms, wherein R¹, R², and R³ can be the same or different and are selected from alkyl groups containing from 1 to 8 carbon atoms and wherein R⁴ is an alkyl group containing from 1 to 7 carbon atoms. In cases where normal-butyl lithium is reacted with bis-(dimethylamino)vinylmethylsilane in a hexane solvent in the presence of tetramethylethylenediamine (TMEDA) this reaction can be depicted as follows:

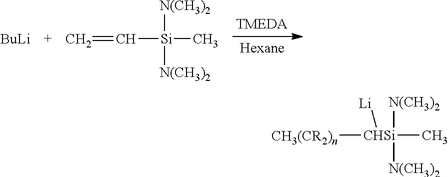

The organolithium compounds which are preferred for use in making the functionalized initiator can be represented by the formula: R—Li, wherein R represents a hydrocarbyl radical containing from 1 to about 20 carbon atoms. Generally, such monofunctional organolithium compounds will contain from 1 to about 7 carbon atoms and will be alkyl lithium compounds. Some representative examples of organolithium compounds which can be employed include methyllithium, ethyllithium, isopropyllithium, n-butyllithium, sec-butyllithium, n-octyllithium, tert-octyllithium, n-decyllithium, phenyllithium, 1-napthyllithium, 4-butylphenyllithium, p-tolyllithium, 1-naphthyllithium, 4-butylphenyllithium, p-tolyllithium, 4-phenylbutyllithium, cyclohexyllithium, 4-butylcyclohexyllithium, and 4-cyclohexylbutyllithium. Organo monolithium compounds, such as alkyllithium compounds and aryllithium compounds, are usually employed. Some representative examples of preferred organo monolithium compounds that can be utilized include ethylaluminum, isopropylaluminum, n-butyllithium, secondary-butyllithium, normal-hexyllithium, tertiary-octyllithium, phenyllithium, 2-napthyllithium, 4-butylphenyllithium, 4-phenylbutyllithium, cyclohexyllithium, and the like. Normal-butyllithium and secondary-butyllithium are highly preferred lithium initiators.

In making the functionalized initiator a stoichiometric ratio of the lithium compound to the bis-(dialkylamino)vinylalkylsilane will typically be used. For instance, the molar ratio of mono-lithium compounds to bis-(dialkylamino)vinylalkylsilane will typically be within the range of 0.5:1 to 1.2:1 with molar ratios which are within the range of 0.9:1 to 1.1:1 being preferred.

As previously noted, the lithium compound is reacted with the bis-(dialkylamino)vinylalkylsilane in the presence of a polar modifier to make the functionalized initiator. The polar modifier used is typically selected from ethers and tertiary amines which act as Lewis bases. Some representative examples of polar modifiers that can be utilized include diethyl ether, di-n-propyl ether, diisopropyl ether, di-n-butyl ether, tetrahydrofuran, dioxane, ethylene glycol dimethyl ether, ethylene glycol diethyl ether, diethylene glycol dimethyl ether, diethylene glycol diethyl ether, triethylene glycol dimethyl ether, trimethylamine, triethylamine, N,N,N′,N′-tetramethylethylenediamine (TMEDA), N-methyl morpholine, N-ethyl morpholine, N-phenyl morpholine, 1,2,3-trimethoxybenzene, 1,2,3-triethoxybenzene, 1,2,3-tributoxybenzene, 1,2,3-trihexoxybenzene, 4,5,6-trimethyl-1,2,3-trimethoxybenzene, 4,5,6-tri-n-pentyl-1,2,3-triethoxybenzene, 5-methyl-1,2,3-trimethoxybenzene, 5-propyl-1,2,3-trimethoxybenzene, 1,2,4-trimethoxybenzene, 1,2,4-triethoxybenzene, 1,2,4-tributoxybenzene, 1,2,4-tripentoxybenzene, 3,5,6-trimethyl-1,2,4-trimethoxybenzene, 5-propyl-1,2,4-trimethoxybenzene, and 3,5-dimethyl-1,2,4-trimethoxybenzene.

The amount of functionalized lithium initiator utilized in synthesizing the functionalized rubber will vary from one functionalized lithium initiator to another and with the molecular weight that is desired for the functionalized rubber being synthesized. As a general rule, as in all anionic polymerizations, the molecular weight (Mooney viscosity) of the polymer produced is inversely proportional to the amount of catalyst utilized. In any case, from about 0.01 phm (parts per hundred parts by weight of monomer) to 1 phm of the functionalized lithium catalyst will typically be employed. In most cases, from 0.01 phm to 0.1 phm of the functionalized lithium catalyst will be employed with it being preferred to utilize 0.025 phm to 0.07 phm of the functionalized lithium initiator.

Normally, the polymerization medium will be charged with from about 5 weight percent to about 35 weight percent of monomer(s), based upon the total weight of the polymerization medium (including the organic solvent and monomers). In most cases, it will be preferred for the polymerization medium to contain from about 10 weight percent to about 30 weight percent monomer. It is typically more preferred for the polymerization medium to contain from about 20 weight percent to about 25 weight percent monomer.

The microstructure of the rubbery polymer being synthesized is somewhat dependent upon the polymerization temperature. In any case, the polymerization temperature will normally be within the range of about 5° C. to about 100° C. The polymerization temperature will preferably be within the range of about 40° C. to about 90° C. for practical reasons and to attain the desired polymer microstructure. Polymerization temperatures within the range of about 60° C. to about 90° C. are generally most preferred.

To increase the level of vinyl content the polymerization is normally carried out in the presence of at least one polar modifier. The types of polar modifiers previously described for use in making the functionalized lithium initiator can be used for this purpose. In fact, the polymerization can be carried out with the same polar modifier as was employed in making the functionalized lithium initiator, such as TMEDA. Ethers and tertiary amines which act as Lewis bases as well 1,2,3-trialkoxybenzenes and 1,2,4-trialkoxybenzenes as are representative examples of polar modifiers that can be utilized in the polymerization for the purpose of increasing the vinyl content of the rubbery polymer being synthesized. Dipiperidinoethane, dipyrrolidinoethane, N,N,N′,N′-tetramethylethylenediamine (TMEDA), diethylene glycol, dimethyl ether, and tetrahydrofuran are representative of highly preferred modifiers.

U.S. Pat. No. 4,022,959 describes the use of ethers and tertiary amines as polar modifiers in greater detail. The utilization of 1,2,3-trialkoxybenzenes and 1,2,4-trialkoxybenzenes as modifiers is described in greater detail in U.S. Pat. No. 4,696,986.

The teachings of U.S. Pat. Nos. 4,022,959 and 4,696,986 are incorporated herein by reference in their entirety for the purpose of describing polar modifiers and the way that they can be used in modifying the polymerization of rubbery polymers.

In any case, the microstructure of the repeat units which are derived from conjugated diolefin monomers is a function of the polymerization temperature and the amount of polar modifier present. For example, it is known that higher polymerization temperatures result in lower vinyl contents (lower levels of 1,2-microstructure). Accordingly, the polymerization temperature, quantity of modifier, and specific modifier selected will be determined with the ultimate desired microstructure of the functionalized rubber being synthesized being kept in mind.

It has been found that a combination of a metal salt of a cyclic alcohol and a polar modifier act synergistically to increase the vinyl content of rubbery polymer synthesized in their presence. The utilization of this synergistic modifier system can also be employed advantageously in the synthesis of a wide variety of functionalized rubbery polymers, such as functionalized high vinyl polybutadiene rubber, functionalized styrene-butadiene rubber (SBR), functionalized styrene-isoprene-butadiene rubber (SIBR), and functionalized isoprene-butadiene rubber.

The metal salt of the cyclic alcohol will typically be a Group Ia metal salt. Lithium, sodium, potassium, rubidium, and cesium salts are representative examples of such salts with lithium, sodium, and potassium salts being preferred. Sodium salts are typicaly the most preferred. The cyclic alcohol can be mono-cyclic, bi-cyclic or tri-cyclic and can be aliphatic or aromatic. They can be substituted with 1 to 5 hydrocarbon moieties and can also optionally contain hetero-atoms. For instance, the metal salt of the cyclic alcohol can be a metal salt of a di-alkylated cyclohexanol, such as 2-isopropyl-5-methylcyclohexanol or 2-t-butyl-5-methylcyclohexanol. These salts are preferred because they are soluble in hexanes as well as most other common organic solvents. Metal salts of disubstituted cyclohexanol are highly preferred because they are soluble in for this reason and because they provide similar modification efficiencies to sodium t-amylate. Sodium mentholate is a highly preferred metal salt of a cyclic alcohol that can be empolyed in the practice of this invention. Metal salts of thymol can also be utilized. The metal salt of the cyclic alcohol can be prepared by reacting the cyclic alcohol directly with the metal or another metal source, such as sodium hydride, in an aliphatic or aromatic solvent.

The molar ratio of the metal salt of the cyclic alcohol to the polar modifier will normally be within the range of about 0.1:1 to about 10:1 and the molar ratio of the metal salt of the cyclic alcohol to the lithium initiator will normally be within the range of about 0.01:1 to about 20:1. It is generally preferred for the molar ratio of the metal salt of the cyclic alcohol to the polar modifier to be within the range of about 0.2:1 to about 5:1 and for the molar ratio of the metal salt of the cyclic alcohol to the lithium initiator to be within the range of about 0.05:1 to about 10:1. It is generally more preferred for the molar ratio of the metal salt of the cyclic alcohol to the polar modifier to be within the range of about 0.5:1 to about 1:1 and for the molar ratio of the metal salt of the cyclic alcohol to the lithium initiator to be within the range of about 0.2:1 to about 3:1.

(2) Allowing the Polymerization to Continue in the Inert Organic Liquid Medium Until a Desired Level on Monomer Conversion Has Been Attained to Produce a Rubbery Polymer Having Living Polymer Chains:

The polymerization is allowed to continue until essentially all of the monomer has been exhausted. In other words, the polymerization is allowed to run to completion. Since a lithium catalyst is employed to polymerize the monomer, a living polymer is produced. The living polymer synthesized will typically have a number average molecular weight which is within the range of about 25,000 to about 700,000. The rubber synthesized will more typically have a number average molecular weight which is within the range of about 150,000 to about 400,000.

(3) Adding a Polymerization Terminator to the Living Polymer Chains to Produce the Functionalized Rubber:

After the desired level of monomer conversion has been attained, a functionalized terminator is added to the polymerization medium (the inert organic liquid medium in which the polymerization is conducted). Some representative examples of functional terminators that can be used include compounds of the following structural formulas (V)-(IX):

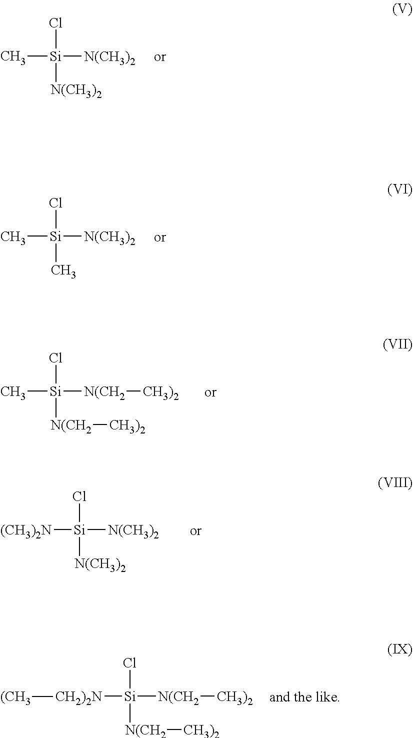

These functional terminators and their use in functionalizing living polymers are further described in commonly owned U.S. Pat. No. 11,117,997, the content of which is entirely incorporated herein.

The reaction with the functional terminator causes the functional groups in the polymer to react—forming functionalization in the backbone of the living rubbery polymer. Such functionalized living polymers are of the formula:

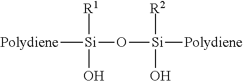

wherein Polydiene and Polydiene represent polymer chains which are independently comprised of at least one diene monomer and wherein R¹ and R² can be the same or different and represent alkyl groups containing form 1 to 8 carbon atoms.

Any remaining living chain ends in the rubbery polymer can then optionally be coupled with a suitable coupling agent, such as a tin halide or a silicon halide. Typically tin tetrahalide or a silicon tetrahalide, such a tin tetrachloride, tin tetrabromide, silicon tetrachloride, or silicon tetrabromide, is preferred for use as the coupling agent. In another embodiment of this invention the living rubbery polymer is coupled before the functionalized terminator is added. However, in this scenario it is important to limit the level of coupling agent employed to an amount which is insufficient to couple with all of the living chain ends of the rubbery polymer (less than a stoichiometric level of the coupling agent is added). This is, of course, because it is critical for living chain ends to be available to react with the functionalized terminator which will be added in a subsequent step.

(4) Hydrogenating the Functionalized Rubber to Saturate it to A Select Level:

The functionalized polydiene may then undergo a hydrogenation reaction to selectively saturate the functionalized polymer to a desired level. By this reaction, a select amount of double bonds in the polydiene rubber are converted to single bonds. This reduces the number of unsaturation points that are susceptible to ozone degradation in the final polymer, thus improving aging. The hydrogenation reaction is selectively terminated after full or partial conversion of the double bonds in the polymer.

(5) Distributing Throughout the Inert Organic Liquid Medium an Acid And Water Under Conditions of Agitation:

After the rubbery polymer has been treated with the functionalized terminator and has optionally been coupled any remaining living chain ends are killed. A wide variety of organic and inorganic acids can be used for this purpose. For instance, inorganic acids, such as hydrochloric acid or sulfuric acid can be used. However, it is typically preferred to utilize an organic acid, such as a carboxylic acid, for this purpose. The carboxylic acids that can be used are typically of the structural formula: R—COOH, wherein R represents a hydrocarbyl moiety containing from 1 to about 30 carbon atoms, such as acetic acid or stearic acid. It is normally preferred for such carboxylic acids to contain from about 10 to about 25 carbon atoms, and more preferably from about 15 to 20 carbon atoms. Stearic acid is highly preferred.

The acid and the water can be added to the polymerization medium separately or as a mixed stream. It is typically preferred to add the water and the acid separately since the acid may not be water soluble. In any case, this addition will be done under conditions of agitation to mix the acid and the water throughout the polymerization medium. Normally from about 0.1 phr to about 5 phr of the acid and from about 0.1 phr to about 5 phr of water will be added. More typically, from about 0.5 phr to about 2 phr of the acid and from about 0.5 phr to about 2 phr of water will be added. Normally from about 0.1 phr to about 5 phr of the acid and from about 0.1 phr to about 5 phr of water will be added. More typically, from about 0.8 phr to about 1.2 phr of the acid and from about 0.8 phr to about 1.2 phr of water will be added.

The acid/water treatment has been unexpectedly found to result in the polymer being stable upon subsequent storage for a period of at least 2 weeks. More specifically, the rubbery polymer exhibits little or no Mooney creep after storage for 2 weeks. This is, of course, highly desirable in commercial scale production.

(6) Recovering the Functionalized Rubber from the Inert Liquid Organic Medium:

The rubbery polymer is then recovered from the organic solvent. The polybutadiene rubber can be recovered from the organic solvent and residue by any means, such as decantation, filtration, certification, and the like. It is often desirable to precipitate the rubbery polymer from the organic solvent by the addition of lower alcohols containing from about 1 to about 4 carbon atoms to the polymer solution. Suitable lower alcohols for precipitation of the rubbery polymer from the polymer cement include methanol, ethanol, isopropyl alcohol, normal-propyl alcohol and t-butyl alcohol. The utilization of lower alcohols to precipitate the rubber from the polymer cement also “kills” the living polymer by inactivating lithium end groups. In any case, after the rubbery polymer is recovered from the solution, steam stripping is typically employed to reduce the level of volatile organic compounds in the polymer. It should be noted that steam stripping also kills any remaining living chain ends. The inert solvent and residual monomer can then be recycled for subsequent polymerization.

The functionalized rubber can then be finished and recovered from the polymerization medium using conventional techniques. In any case, it produces a functionalized rubber which is comprised of polymer chains of the structural formula:

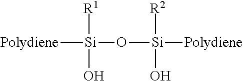

wherein Polydiene represents a polymer chain which is comprised of at least one diene monomer and wherein R¹ and R² can be the same or different and represent alkyl groups containing form 1 to 8 carbon atoms.

The hydrogenated functionalized polymer may be incorporated in a variety of rubber articles including, but not limited to, components for a tire, coated metal, coated wire, coated cord, hoses, belts, and shoe soles. For example, a rubber tire component may be a tread (including tread cap and tread base), sidewall, apex, chafer, sidewall insert, wirecoat or innerliner. In one embodiment, the component is a tread. In a tread, the disclosed hydrogenated functionalized polymer has better aging and is contemplated to maintain or improve performance, via an improved polymer-filler interaction among other things. Using tire tread compounds as an illustrative example, the disclosed hydrogenated functionalized polymer may result in improved traction and rolling resistance—the latter being a result of reduced hysteresis.

For illustrative examples, a tire rubber is described. The functionalized polydiene rubbers of this invention can be compounded utilizing conventional ingredients and standard techniques. For instance, the functionalized polydiene rubber will typically be mixed with carbon black and/or silica, sulfur, fillers, accelerators, oils, waxes, scorch inhibiting agents, and processing aids. In most cases, the functionalized polydiene rubber will be compounded with sulfur and/or a sulfur containing compound, at least one filler, at least one accelerator, at least one antidegradant, at least one processing oil, zinc oxide, optionally a tackifier resin, optionally a reinforcing resin, optionally one or more fatty acids, optionally a peptizer and optionally one or more scorch inhibiting agents. Such blends will normally contain from about 0.5 to 5 phr (parts per hundred parts of rubber by weight) of sulfur and/or a sulfur containing compound with 1 phr to 2.5 phr being preferred. It may be desirable to utilize insoluble sulfur in cases where bloom is a problem.

Normally from 10 phr to 165 phr of at least one filler will be utilized with 30 phr to 80 phr being preferred. In most cases at least some carbon black will be utilized as the filler. The filler can, of course, be comprised totally of carbon black. Silica can be included in the filler to improve tear resistance and heat buildup. Clays and/or talc can be included in the filler to reduce cost. The productive rubber compounds will also normally include from 0.1 phr to 4 phr of at least one accelerator with 0.2 phr to 1.5 phr being preferred. Antidegradants, such as antioxidants and antiozonants, will generally be included in the rubber compound in amounts ranging from 0.25 phr to 10 phr with amounts in the range of 1 phr to 5 phr being preferred. Processing oils will generally be included in the blend in amounts ranging from 2 phr to 100 phr with amounts ranging from 5 phr to 50 phr being preferred. The compounded functionalized polydiene rubbers of this invention will also normally contain from 0.5 phr to 10 phr of zinc oxide with 1 phr to 5 phr being preferred. Up to 60 phr resin(s) can be used. These blends can optionally contain from 0 phr to 10 phr of tackifier resins, 0 phr to 10 phr of reinforcing resins, 1 phr to 10 phr of fatty acids, 0 phr to 2.5 phr of peptizers, and 0 phr to 1 phr of scorch inhibiting agents.

An extending oil can also optionally be added to the cement of the rubbery polymer. Such extending oils will typically be added at a level which is within the range of 0 phr to 50 phr. In the case of oil extended rubbers the oil will more typically be added in an amount which is within the range of 10 phr to 45 phr, and will most typically be added at a level which is within the range of 20 phr to 35 phr.

To fully realize the total advantages of the functionalized polydiene rubbers of this invention, silica will normally be included in the tread rubber formulation. Various commercially available silicas may be considered for use in the practice of this invention. Some representative examples of silica that can be used in the practice of this invention includes, but is not limited to, silicas commercially available from PPG Industries under the Hi-Sil trademark, such as Hi-Sil® 210 and Hi-Sil® 243, silicas available from Rhone-Poulenc, with, for example, designations of Z1165MP and Z165GR and silicas available from Degussa AG with, for example, designations VN2, VN3, and BV9000GR. Zeopol® 8745 silica from J. M. Huber Corporation, reportedly having an average total of about 13 hydroxyl groups per square nanometer of silica surface area and a ratio of geminal hydroxyl groups to said average total of about 0.23/1; a CTAB value of about 145 m2/g and a BET value of about 185 m2/g can also be used in the practice of this invention. Zeopol® 8715 silica from J.M Huber Corporation reportedly characterized by having an average total of about 18 hydroxyl groups per square nanometer surface of said silica and a ratio of geminal hydroxyl groups to said average total of about 0.27/1, a CTAB value of about 94 m2/g and a BET value of about 163 m2/g is another example of a silica that can be used in the practice of this invention.

The commonly employed siliceous pigments used in rubber compounding applications can be used as the silica. For instance, the silica can include pyrogenic and precipitated siliceous pigments (silica), although precipitate silicas are preferred. The siliceous pigments preferably employed in this invention are precipitated silicas such as, for example, those obtained by the acidification of a soluble silicate, e.g., sodium silicate. Such silicas might be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, page 304 (1930).

The silica may also be typically characterized by having a dibutylphthalate (DBP) absorption value in a range of about 100 to about 400, and more usually about 150 to about 300. The silica might be expected to have an average ultimate particle size, for example, in the range of 0.01 to 0.05 micron as determined by the electron microscope, although the silica particles may be even smaller, or possibly larger, in size.

Various commercially available silicas may be considered for use in this invention such as, only for example herein, and without limitation, silicas commercially available from PPG Industries under the Hi-Sil trademark with designations 210, 243, etc; silicas available from Rhone-Poulenc, with, for example, designations of Z1165MP and Z165GR and silicas available from Degussa AG with, for example, designations VN2 and VN3.

The processing of the functionalized polydiene rubber is normally conducted in the presence of a sulfur containing organosilicon compound to realize maximum benefits. Examples of suitable sulfur containing organosilicon compounds are of the formula:

Z—Alk—SₙAlk—Z

in which Z is selected from the group consisting of:

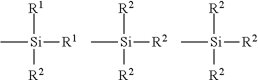

where R¹ is an alkyl group of 1 to 4 carbon atoms, cyclohexyl or phenyl; wherein R² is alkoxy of 1 to 8 carbon atoms, or cycloalkoxy of 5 to 8 carbon atoms; and wherein Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl) disulfide, 3,3′-bis(triethoxysilylpropyl) tetrasulfide, 3,3′-bis(triethoxysilylpropyl) octasulfide, 3,3′-bis(trimethoxysilylpropyl) tetrasulfide, 2,2′-bis(triethoxysilylethyl) tetrasulfide, 3,3′-bis(trimethoxysilylpropyl) trisulfide, 3,3′-bis(triethoxysilylpropyl) trisulfide, 3,3′-bis(tributoxysilylpropyl) disulfide, 3,3′-bis(trimethoxysilylpropyl) hexasulfide, 3,3′-bis(trimethoxysilylpropyl) octasulfide, 3,3′-bis(trioctoxysilylpropyl) tetrasulfide, 3,3′-bis(trihexoxysilylpropyl) disulfide, 3,3′-bis(tri-2″-ethylhexoxysilylpropyl) trisulfide, 3,3′-bis(triisooctoxysilylpropyl) tetrasulfide, 3,3′-bis(tri-t-butoxysilylpropyl) disulfide, 2,2′-bis(methoxy diethoxy silyl ethyl) tetrasulfide, 2,2′-bis(tripropoxysilylethyl) pentasulfide, 3,3′-bis(tricyclonexoxysilylpropyl) tetrasulfide, 3,3′-bis(tricyclopentoxysilylpropyl) trisulfide, 2,2′-bis(tri-2″-methylcyclohexoxysilylethyl) tetrasulfide, bis(trimethoxysilylmethyl) tetrasulfide, 3-methoxy ethoxy propoxysilyl 3′-diethoxybutoxy-silylpropyltetrasulfide, 2,2′-bis(dimethyl methoxysilylethyl) disulfide, 2,2′-bis(dimethyl sec.butoxysilylethyl) trisulfide, 3,3′-bis(methyl butylethoxysilylpropyl) tetrasulfide, 3,3′-bis(di t-butylmethoxysilylpropyl) tetrasulfide, 2,2′-bis(phenyl methyl methoxysilylethyl) trisulfide, 3,3′-bis(diphenyl isopropoxysilylpropyl) tetrasulfide, 3,3′-bis(diphenyl cyclohexoxysilylpropyl) disulfide, 3,3′-bis(dimethyl ethylmercaptosilylpropyl) tetrasulfide, 2,2′-bis (methyl dimethoxysilylethyl) trisulfide, 2,2′-bis(methyl ethoxypropoxysilylethyl) tetrasulfide, 3,3′-bis(diethyl methoxysilylpropyl) tetrasulfide, 3,3′-bis(ethyl di-sec. butoxysilylpropyl) disulfide, 3,3′-bis(propyl diethoxysilylpropyl) disulfide, 3,3′-bis(butyl dimethoxysilylpropyl) trisulfide, 3,3′-bis(phenyl dimethoxysilylpropyl) tetrasulfide, 3-phenyl ethoxybutoxysilyl 3′-trimethoxysilylpropyl tetrasulfide, 4,4′-bis(trimethoxysilylbutyl) tetrasulfide, 6,6′-bis(triethoxysilylhexyl) tetrasulfide, 12,12′-bis(triisopropoxysilyl dodecyl) disulfide, 18,18′-bis(trimethoxysilyloctadecyl) tetrasulfide, 18,18′-bis(tripropoxysilyloctadecenyl) tetrasulfide, 4,4′-bis(trimethoxysilyl-buten-2-yl) tetrasulfide, 4,4′-bis(trimethoxysilylcyclohexylene) tetrasulfide, 5,5′-bis(dimethoxymethylsilylpentyl) trisulfide, 3,3′-bis(trimethoxysilyl-2-methylpropyl) tetrasulfide, 3,3′-bis(dimethoxyphenylsilyl-2-methylpropyl) disulfide.

The preferred sulfur containing organosilicon compounds are the 3,3′-bis(trimethoxy or triethoxy silylpropyl) sulfides. The most preferred compound is 3,3′-bis(triethoxysilylpropyl) tetrasulfide. Therefore as to formula I, preferably Z is

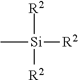

where R² is an alkoxy of 2 to 4 carbon atoms, with 2 carbon atoms being particularly preferred; Alk is a divalent hydrocarbon of 2 to 4 carbon atoms with 3 carbon atoms being particularly preferred; and n is an integer of from 3 to 5 with 4 being particularly preferred.

The amount of the sulfur containing organosilicon compound in a rubber composition will vary depending on the level of silica that is used. Generally speaking, the amount of the compound of formula I will range from about 0.01 to about 1.0 parts by weight per part by weight of the silica. Preferably, the amount will range from about 0.02 to about 0.4 parts by weight per part by weight of the silica. More preferably the amount of the compound of formula I will range from about 0.05 to about 0.25 parts by weight per part by weight of the silica.

In addition to the sulfur containing organosilicon, the rubber composition should contain a sufficient amount of silica, and carbon black, if used, to contribute a reasonably high modulus and high resistance to tear. The silica filler may be added in amounts ranging from about 10 phr to about 250 phr. Preferably, the silica is present in an amount ranging from about 15 phr to about 80 phr. If carbon black is also present, the amount of carbon black, if used, may vary. Generally speaking, the amount of carbon black will vary from about 5 phr to about 80 phr. Preferably, the amount of carbon black will range from about 10 phr to about 40 phr. It is to be appreciated that the silica coupler may be used in conjunction with a carbon black, namely pre-mixed with a carbon black prior to addition to the rubber composition, and such carbon black is to be included in the aforesaid amount of carbon black for the rubber composition formulation. In any case, the total quantity of silica and carbon black will be at least about 30 phr. The combined weight of the silica and carbon black, as hereinbefore referenced, may be as low as about 30 phr, but is preferably from about 45 to about 130 phr.

Rubber formulations made in accordance with this invention which includes silica and an organosilicon compound will typically be mixed utilizing a thermomechanical mixing technique. The mixing of the tire tread rubber formulation can be accomplished by methods known to those having skill in the rubber mixing art. For example, the ingredients are typically mixed in at least two stages, namely at least one non-productive stage followed by a productive mix stage. The final curatives including sulfur vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The rubber, silica and sulfur containing organosilicon, and carbon black if used, are mixed in one or more non-productive mix stages. The terms “non-productive” and “productive” mix stages are well known to those having skill in the rubber mixing art. The sulfur vulcanizable rubber composition containing the sulfur containing organosilicon compound, vulcanizable rubber and generally at least part of the silica should be subjected to a thermomechanical mixing step. The thermomechanical mixing step generally comprises a mechanical working in a mixer or extruder for a period of time suitable in order to produce a rubber temperature which is within the range of 140° C. to 190° C. The appropriate duration of the thermomechanical working varies as a function of the operating conditions and the volume and nature of the components. For example, the thermomechanical working may be for a duration of time which is within the range of about 2 minutes to about 20 minutes. It will normally be preferred for the rubber to reach a temperature which is within the range of about 145° C. to about 180° C. and to be maintained at said temperature for a period of time which is within the range of about 4 minutes to about 12 minutes. It will normally be more preferred for the rubber to reach a temperature which is within the range of about 155° C. to about 170° C. and to be maintained at said temperature for a period of time which is within the range of about 5 minutes to about 10 minutes. By utilizing the functionalized rubbers of this invention in tire tread compounds, traction characteristics can be improved without compromising tread wear or rolling resistance.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A hydrogenated functionalized polymer comprising:
a functionalized polydiene being selectively hydrogenated to a predetermined level of saturation along at least a polydiene portion of the functionalized polydiene, wherein the functionalized polydiene produced from a living anionic elastomer initiated with a functionalized lithium initiator of the formula (I) 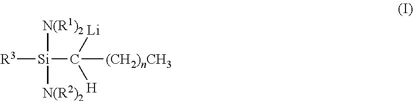
wherein n is an integer from 1 to 8, wherein R¹, R², and R³ can be the same or different and are selected from alkyl groups containing from 1 to 8 carbon atom;
wherein the polymer has chains of the structural formula (II) 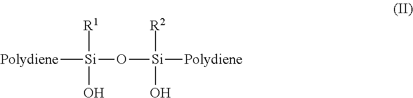
wherein polydiene represents polymer chains comprising at least one partially or fully hydrogenated diene monomer and wherein R¹ and R² can be the same or different and represent alkyl groups containing from 1 to 8 carbon atoms.

2. The polymer of claim 1, wherein R¹, R², and R³ represent alkyl groups containing from 1 to 4 carbon atoms.

3. The rubber polymer of claim 1, wherein prior to hydrogenation the each polydiene is independently selected from a group consisting of: polybutadiene rubber; polyisoprene rubber;
styrene-butadiene rubber; styrene-isoprene rubber; and styrene-isoprene-butadiene rubber.

4. The polymer of claim 1, wherein the Polydiene portion is fully saturated by hydrogenation.

5. The polymer of claim 1, wherein the Polydiene portion is from about 10 percent to about 40 percent saturated by hydrogenation of the functionalized polymer.

6. The polymer of claim 1, wherein the Polydiene portion is from about 40 percent to about 80 percent saturated by hydrogenation of the functionalized polymer.

7. The polymer of claim 1, wherein the Polydiene portion is from about 80 percent to about 100 percent saturated by hydrogenation of the functionalized polymer.

8. The polymer of claim 1, wherein the polymer is incorporated in a rubber composition further comprising silica and/or carbon black.

9. The polymer of claim 1, wherein the polymer is incorporated in one of a rubber tire, hose, belt, and shoe.

10. A hydrogenated functionalized polymer comprising:
a functionalized polydiene being selectively hydrogenated to a predetermined level of saturation along at least a polydiene portion of the functionalized polydiene, wherein the functionalized polydiene is a reaction product of a living anionic elastomeric polymer terminated with a polymerization terminator of formula III: 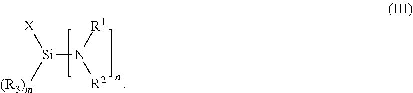
wherein X is selected from the group consisting of chlorine atoms, bromine atoms, and iodine atoms;
wherein m is an integer from 0 to 2, and n is an integer from 1 to 3, with the proviso that n+m=3;
wherein R¹ and R² are independently alkyl groups or aryl groups containing from 1 to 18 carbon atoms, or
wherein R¹, R² are independently -SiR⁴ groups, wherein R⁴ is independently selected from alkyl groups, aryl groups, alkoxy groups, or disubstituted amino groups, or
wherein R¹ and R² taken together with a common nitrogen atom and optionally a sulfur or oxygen heteroatom form a five to eight membered ring; and
wherein R³ is hydrogen, or C1 to C18 alkyl, aryl, or a combination thereof, or R³ is selected from —R⁵ and —R⁶, where R⁵ is alkanediyl containing from 1 to 3 carbon atoms, and R⁶ is selected from the following structures —S—Z, —N(R⁷)(R⁸), —O(Y), and Si(OR⁹)3, wherein R⁷ and R⁸ are independently selected from alkyl groups and aryl groups containing from 1 to 18 carbon atoms, Y and Z are independently selected from the group consisting of methoxymethyl groups, tetrahydropyranyl groups, tetrahydrothiopyranyl groups, tetrahydrofuranyl groups, tert-butyl groups, allyl groups, 1-ethoxyethyl groups, benzyl groups, triphenylmethyl groups, triethylsilyl groups, triisopropylsilyl groups, trimethylsilyl groups, tert-butyl dimethyl silyl groups, tert-butyl diphenyl silyl groups, and isopropyldimethylsilyl groups, and wherein R⁹ is represents an alkyl group containing from 1 to 4 carbon atoms.

11. The polymer of claim 10, wherein the polymerization terminator is selected from the group of the following structures: 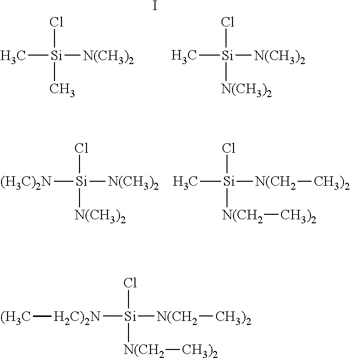
and
wherein the living rubbery polymer is derived from at least one diene monomer selected from the group consisting of 1,3-butadiene and isoprene.

12. The functionalized rubber of claim 10 wherein prior to hydrogenation the each polydiene is independently selected from a group consisting of: polybutadiene rubber; polyisoprene rubber;
styrene-butadiene rubber; styrene-isoprene rubber; and styrene-isoprene-butadiene rubber.

13. A hydrogenated functionalized rubber polymer having chains of the structural formula I: 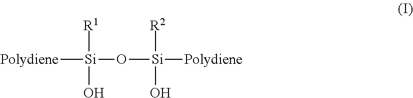
wherein each polydiene comprises at least one diene monomer at least partially saturated by hydrogenation, and wherein R¹ and R² independently represent alkyl groups containing from 1 to 8 carbon or moieties of the formula II: 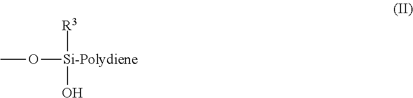
wherein R³ represents alkyl groups containing from 1 to 8 carbon atoms.

14. The polymer of claim 10, wherein the Polydiene portion is fully saturated by hydrogenation.

15. The polymer of claim 10, wherein the Polydiene portion is from about 10 percent to about 40 percent saturated by hydrogenation of the functionalized polymer.

16. The polymer of claim 10, wherein the Polydiene portion is from about 40 percent to about 80 percent saturated by hydrogenation of the functionalized polymer.

17. The polymer of claim 10, wherein the Polydiene portion is from about 80 percent to about 100 percent saturated by hydrogenation of the functionalized polymer.

18. The polymer of claim 10, wherein the polymer is incorporated in a rubber composition further comprising silica and/or carbon black.

19. The polymer of claim 10, wherein the polymer is incorporated in one of a rubber tire, hose, belt, and shoe.
